(19) United States
(12) Patent Application Publication
(10) Pub. No.: US 2018/0345705 A1
(43) Pub. Date: Dec. 6, 2018

(54) PRINT RIBBON HAVING BACKGROUND PANELS

(71) Applicant: Assa Abloy AB, Stockholm (SE)

(72) Inventor: Brent Lien, Minneapolis, MN (US)

(21) Appl. No.: 15/871,527

(22) Filed: Jan. 15, 2018

Related U.S. Application Data
(60) Provisional application No. 62/515,034, filed on Jun. 5, 2017.

(51) Int. Cl. B41J 33/02; B41J 2/475; B41J 2/335; B32B 38/00

(52) U.S. Cl. CPC B41J 33/02; B41J 2/475; B32B 2425/00; B32B 38/145; B41J 2202/35; B41J 2/33535

(57) ABSTRACT

Card substrate printers, such as credential production devices, are generally configured to print images to plastic substrates to form identification cards, driver's licenses, credit cards, and other items. The image printing process that is performed by the printer may be a direct-to-card printing operation, in which a print unit prints an image directly to a surface of the substrate. Alternatively, the image printing process may involve a reverse-image printing process, during which a print unit prints an image to an intermediate substrate, such as a transfer film, and the printed image is transferred from the intermediate substrate to a surface of the card substrate to complete the printing process.

### CROSS-REFERENCE TO RELATED APPLICATION

The present application is based on and claims the benefit of U.S. provisional patent application Ser. No. 62/515,034, filed Jun. 5, 2017, the content of which is hereby incorporated by reference in its entirety.

### BACKGROUND

Card substrate printers, such as credential production devices, are generally configured to print images to plastic substrates to form identification cards, driver's licenses, credit cards, and other items. The image printing process that is performed by the printer may be a direct-to-card printing operation, in which a print unit prints an image directly to a surface of the substrate. Alternatively, the image printing process may involve a reverse-image printing process, during which a print unit prints an image to an intermediate substrate, such as a transfer film, and the printed image is transferred from the intermediate substrate to a surface of the card substrate to complete the printing process.

Card substrate printers may use different types of print units. Thermal print units generally utilize a thermal print head and a print ribbon to print an image. The thermal print head includes numerous resistive heating elements, each of which may be individually activated to heat a select portion of the thermal print ribbon. This heating of the thermal print ribbon causes a print consumable that is adhered to the print ribbon to transfer to the substrate and form a portion of the image. Thermal print ribbons typically include a plurality of colored dye panels, such as a yellow dye panel (Y panel), a magenta dye panel (M panel), and a cyan dye panel (C panel). Print ribbons may also include black resin panels (K panels), and/or other conventional thermal print ribbon panels. To form a colored image, multiple print operations are performed using the print head and one or more of the colored dye panels.

Card substrate printers typically print to white or light-colored substrates, which provide the best viewing experience of the image. As images are printed to increasingly darker substrates, it becomes more difficult to perceive the printed image. As a result, card printers utilizing thermal print units are generally limited to use with white or very light-colored card substrates.

### SUMMARY

Embodiments of the present disclosure are directed to a method of printing an image using a thermal print unit having a print ribbon and a thermal print head. Additional embodiments are directed to a print ribbon for use in the method, and a credential production device.

In one embodiment of the method, a background image is printed to a surface of a substrate comprising transferring a light-colored resin from a background panel of the print ribbon to the substrate using the thermal print head. Additionally, a primary image is printed to the surface of the substrate including transferring print consumable from the print ribbon to the surface of the substrate using the thermal print head. The primary image overlays or underlays the background image on the substrate.

One embodiment of the print ribbon includes a carrier layer, a plurality of dye panels on the carrier layer, and a plurality of light-colored resin background panels on the carrier layer.

The credential production device includes the print ribbon and may be used to implement the method. In one embodiment, the credential production device includes a transport mechanism and a thermal print unit. The transport mechanism is configured to transport individual card substrates along a processing path. The thermal print unit includes a print ribbon and a print head configured to print images using the print ribbon. The print ribbon includes a carrier layer, a plurality of dye panels on the carrier layer, and a plurality of light-colored resin background panels on the carrier layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIGS. 1 and 2 respectively are simplified side views of an exemplary direct-to-substrate printing device and an exemplary reverse-image printing device, in accordance with embodiments of the present disclosure.

FIG. 3 is a simplified side cross-sectional view of an exemplary transfer ribbon in accordance with embodiments of the present disclosure.

FIG. 4 is a simplified top plan view of a portion of an exemplary print ribbon in accordance with embodiments of the present disclosure.

FIG. 5 is a simplified side cross-sectional view of an exemplary print ribbon in accordance with embodiments of the present disclosure.

FIG. 6 is a simplified side cross-sectional view of an exemplary imaged substrate in accordance with embodiments of the present disclosure.

FIG. 7 is a simplified top plan view of an exemplary imaged substrate in accordance with embodiments of the present disclosure.

FIGS. 8A-C are top plan views of exemplary substrates having differently colored surfaces that have been imaged in accordance with embodiments of the present disclosure, and in accordance with conventional printing techniques.

FIG. 9 is a simplified side cross-sectional view of an imaged transfer ribbon in accordance with embodiments of the present disclosure.

### DETAILED DESCRIPTION OF ILLUSTRATIVE EMBODIMENTS

Embodiments of the present disclosure are generally directed to a print ribbon for use in a thermal printing process having background panels that may be used to improve perception of a printed image to a substrate. Additional embodiments are directed to methods of printing an image to a substrate using the print ribbon, and a printing device including the print ribbon.

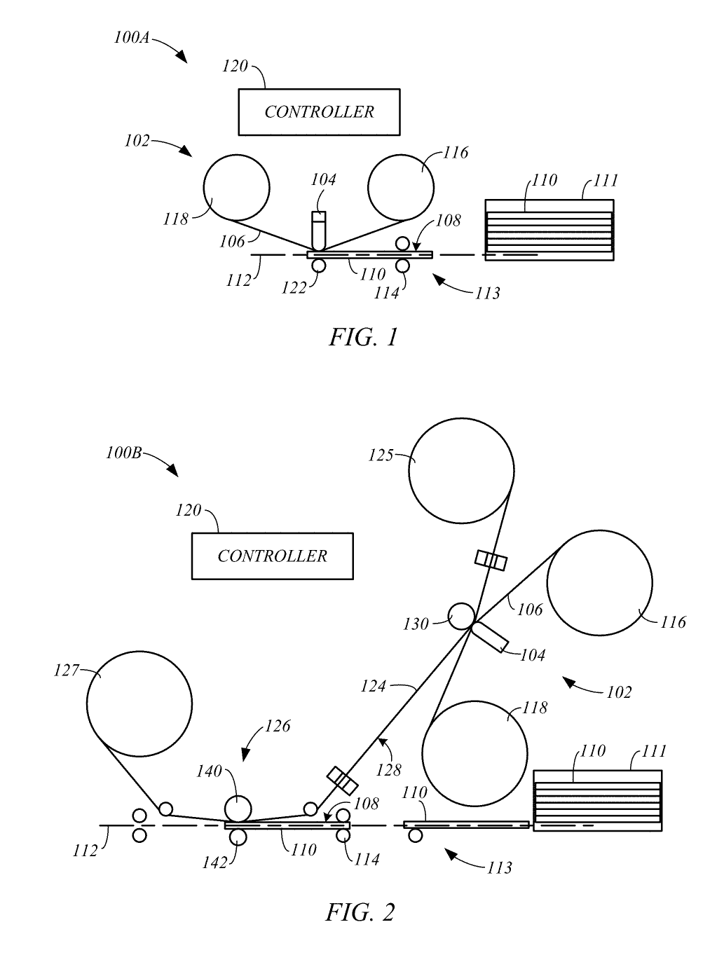

FIGS. 1 and 2 respectively are simplified side views of an exemplary direct-to-substrate printing device 100A and an exemplary reverse-image printing device 100B, in accordance with embodiments of the present disclosure. Each of the devices 100A and 100B includes a thermal print unit 102 having a thermal print head 104 and a print ribbon 106, which is formed in accordance with embodiments of the present disclosure. The thermal print head 104 may be a conventional thermal print head that includes a plurality of individually actuatable print elements, such as resistive heating elements.

The devices 100A and 100B may each be generally configured to print an image to a surface 108 of a substrate 110 fed from a supply 111 along a processing path 112 using a transport mechanism 113, which may include feed rollers 114, or other suitable components. In some embodiments, the print ribbon 106 is supported between a supply roll 116 and a take-up roll 118, which may be motorized to allow the print ribbon to be fed relative to the print head 104.

In some embodiments, the substrates 110 are card substrates. Exemplary card substrates 110 include paper substrates other than traditional paper sheets used in copiers or paper sheet printers, plastic substrates, rigid and semi-rigid substrates, and other similar substrates. In some embodiments, the substrates 110 are credential substrates used to form credentials, such as identification cards, membership cards, proximity cards, driver's licenses, passports, credit and debit cards, and other credentials, or similar products.

The devices 100A and 100B each include a controller 120 representing one or more processors that are configured to execute program instructions stored in memory of the device, such as memory of the controller 120, or other location. The execution of the instructions by a processor of the controller 120 controls components of the corresponding device 100A or 100B to perform functions and method steps described herein, such as a direct-to-substrate or reverse-image printing process, for example.

The device 100A is configured to perform a direct-to-substrate printing operation, during which the print unit 102 is configured to print an image directly to the surface 108 of the substrate 110. During a printing operation, the print head 104 presses exposed print panels of the print ribbon 106 against the surface 108 of the substrate 110, which may be supported by a platen roller 122, for example. As the print ribbon 106 and the substrate 110 are fed past the print head 104, the print elements of the print head 104 are selectively activated by the controller 120 to heat the corresponding portions of the current print panel and transfer a print consumable from the print panel to the surface 108 to form an image, or portion thereof, on the surface 108, in accordance with conventional direct-to-substrate printing techniques. Multiple printing operations may be performed using different colored print panels of the ribbon 104 to form a colored image on the surface 108.

The device 100B is configured to perform a reverse-image printing operation, during which the print unit 102 prints an image to a transfer ribbon 124, and the printed image is transferred from the ribbon 124 to the surface 108 of a substrate 110 using a transfer unit 126, in accordance with conventional reverse-image printing techniques. The transfer ribbon may be supported between a supply roll 125 and a take-up roll 127, which may be motorized to feed the ribbon 124. The image is printed to the transfer ribbon using the print head 104 and the print ribbon 106 using generally the same process as that described above with regard to the device 100A. As the print ribbon 106 and the transfer ribbon 124 are fed past the print head 104, the print elements of the print head 104 are selectively activated by the controller 120 to heat the corresponding portions of the current print panel, and transfer a print consumable from the print panel to a surface 128 of the ribbon 124, which may be supported by a platen 130, to form an image, or portion thereof, on the surface 128, in accordance with conventional reverse-image printing techniques. Multiple printing operations may be performed using different colored print panels of the ribbon 104 to form a colored image on the surface 128.

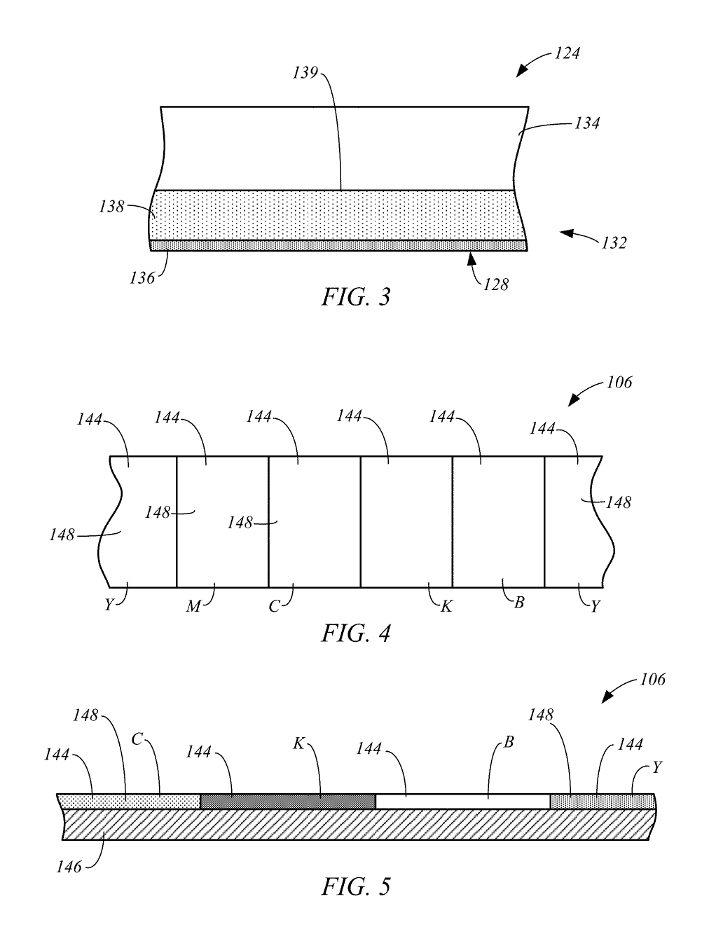

The transfer ribbon 124 includes a transfer layer 132 attached to a backing or carrier layer 134, as shown in FIG. 3, which is a simplified side cross-sectional view of an exemplary transfer ribbon 124, in accordance with embodiments of the present disclosure. The transfer layer 132 may be in the form a fracturable thin-film laminate, or a patch laminate. The transfer layer 132 generally includes an image receptive layer 136 that includes the surface 128 that receives the image from the print unit 102. The image receptive layer 136 may include a thermal adhesive that bonds the transfer layer 132 to the substrate 110 during the transfer operation. The transfer layer 132 may also include a protective layer 138 located between the image receptive layer 106 and the carrier layer 104. The protective layer 110 operates to provide protection to the printed image and the surface 108 of the substrate 110 that receives the transfer layer 132. A release layer 139 may be located between the transfer layer 132 and the carrier layer 134 to facilitate releasing the transfer layer 132 from the carrier layer 134 during the transfer lamination process. The transfer layer 132 may also include other conventional features.

In some embodiments, the transfer unit 126 includes a transfer device 140, such as a conventional heated transfer roller, or other suitable device. During a transfer operation, the transfer device 140 may heat and press a transfer section of the transfer layer 132 containing the printed image to the surface 108 of a substrate 110, which may be supported by a platen roller 142, as the substrate 110 is fed along the processing path 112 by the transport mechanism 113, and the transfer ribbon 124 is fed along with the substrate 110 using conventional techniques. This bonds the imaged transfer section to the surface 108. The carrier layer 134 is then removed from the bonded transfer section to complete the transfer operation and the reverse-image printing of the image to the substrate 110.

As discussed above, embodiments of the print ribbon 106 include print panels 144, as shown in the simplified top plan view of FIG. 4, and in the simplified side cross-sectional view of FIG. 5. Each of the print panels 144 includes a print consumable on a backing or carrier layer 146 (FIG. 5). In some embodiments, the print panels 144 include color dye panels 148 having yellow dye print consumable (Y-panel), magenta dye print consumable (M-panel), and/or cyan dye print consumable (C-panel), for example, as shown in FIG. 4. In some embodiments, the print panels 144 include a black resin print consumable (K-panel). These print ribbon panels 144 are conventionally used by print units 102 to print images to substrates 110 in direct-to-card printing devices 100A and reverse-image printing devices 100B.

As discussed above, it may be difficult to perceive images that are printed to a non-white substrate 110, particularly dark substrates. Embodiments of the print ribbon 106 include one or more background panels B having a print consumable in the form of a light-colored resin, such as a white resin. In some embodiments, the light-colored resin has a sufficient opacity to substantially block (e.g., block at least 70%, 80%, 90%, and/or 95%) viewing of the surface on which it is printed or transferred, such as the surface 108 of the substrate 110, through the printed resin.

In some embodiments, the print ribbon 106 has a repeating series of print panels 144. Each series of the panels 144 includes at least one background panel B in combination with one or more colored dye panels 148 and/or a black resin panel K.

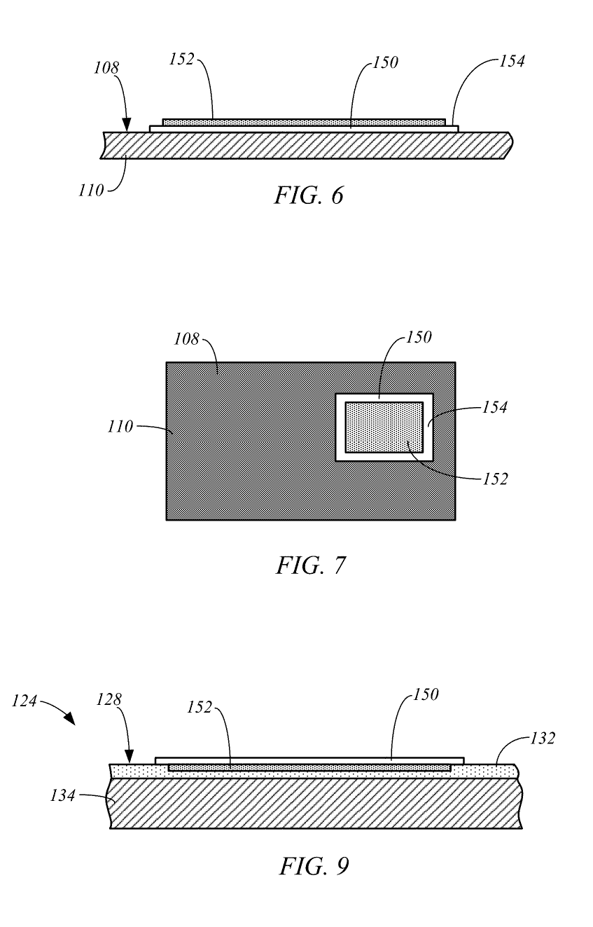

In some embodiments, the background panel B is used to print a background image 150 on the surface 108 of the substrate 110, over which a primary image 152 may be printed, as illustrated in the side cross-sectional view of a printed substrate 110 shown in FIG. 6, and the top view of a printed substrate 110 shown in FIG. 7. This arrangement of the background image 150 and the primary image 152 is most useful when the surface 108 of the substrate 110 has a darker color than the traditional white color of conventional card substrates. The light-colored background image 150, such as white, substantially blocks viewing of the underlying surface 108, and provides significantly greater contrast to the primary image 152. In some embodiments, the background image 150 is formed larger than the primary image 152, as shown in the printed substrates 110 of FIGS. 6 and 7. In some embodiments, this results in a perimeter or border 154 that surrounds the primary image 152.

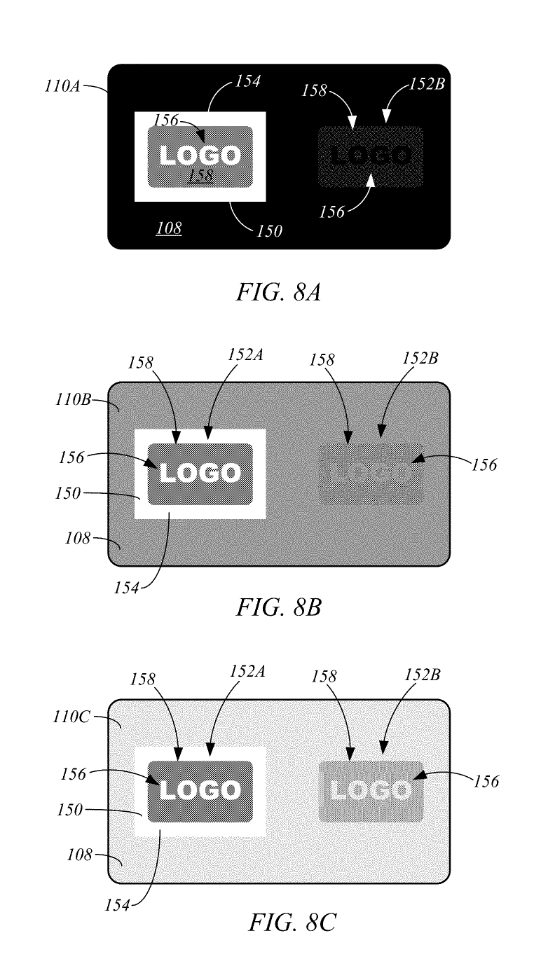

The printing of the primary image 152 over the background image 150 allows for greater perception of the primary image 152 than would be possible if the primary image 152 was printed to the surface 108 of the substrate 110 in accordance with conventional substrate printing techniques. This is generally illustrated in FIGS. 8A-C, which are top plan views of exemplary substrates 110 having differently colored surfaces 108 to which exemplary primary images, generally designated as 152, are printed in accordance with embodiments of the present disclosure as images 152A, and in accordance with conventional printing techniques as images 152B.

The exemplary primary images 152 are identical and include a non-printed portion 156 and a printed portion 158. The non-printed portion 156 corresponds to locations having an absence of printed consumable from the print ribbon 106, while the printed portions 158 are areas containing a print consumable that was directly printed by the print head 104 using the panels 144 of the print ribbon 106. Thus, the printed portions 158 may be any suitable color formed by print consumable from the print ribbon 106, such as a non-white color.

The printed portions 158 define the non-printed portions 156 of the image 152, which may be viewed as text, such as a logo as shown in FIGS. 8A-C, graphics, and/or a combination of text and graphics, for example. Due to the absence of printed consumable in the non-printed portions 156, the non-printed portions 156 have the same color as the background on which the image 152 is formed. As discussed below, it may be difficult to discern or perceive the non-printed portions 156 and the printed portions 158 of images 152, when the images 152 are printed to relatively dark-colored substrates 110.

The printing of each image 152A involves first printing an overlay background image 150 over the surface 108 of the substrate 110, followed by printing the image 152A (e.g., the printed portion 158) on the background image 150. The background image 150 substantially blocks the colored surface 108 of the substrate 110. Thus, the non-printed portion 156 of each image 152A generally has the same color as the background image 150.

When the printed portion 158 is printed using conventional printing techniques to form the primary image 152B on the surface 108 of the substrate 110 without a corresponding background image, the non-printed portion 156 has the same color as the substrate 110. Thus, the non-printed portions 156 of the images 152B have the same color as the surface 108 of the substrate 110 in the examples shown in FIGS. 8A-C.

For the darkest colored (e.g., black, dark grey, navy blue, etc.) substrates 110, such as substrates 110A (FIG. 8A) and substrate 110B (FIG. 8B), the non-printed portions 156 and the printed portions 158 of the primary images 152B are substantially imperceptible, while the primary images 152A overlaying the corresponding background images 150 are highly perceptible. For a more brightly colored (e.g., yellow, red, light blue, light grey, etc.) substrate 110C (FIG. 8C), the perceptibility of the primary image 152A that overlays the background image 150 is improved over the primary image 152B that is printed to the substrate 110C in a conventional manner. Accordingly, the print ribbon 106 and the method of printing the primary image 152 over the background image 150 provides significant advantages over conventional printing techniques when using non-white substrates 110.

When using a direct-to-substrate printing device, such as printing device 100A (FIG. 1), the print unit 102 initially prints the background image 150 to the surface 108 of the substrate 110 using the thermal print head 104, and a background panel B of the print ribbon 106. In some embodiments, the background image 150 is formed during a single printing operation using one of the background panels B of the print ribbon 106. However, when it is desirable to increase the opacity of the background image 150, such as when the color of the surface 108 of the substrate 110 is very dark (e.g., substrate 110A in FIG. 8A), the background image 150 may be formed by printing two or more layers of the light-colored resin from one or more of the background panels B. This builds the layers of the light-colored resin forming the background image 150 on the surface 108 of the substrate 110. Each layer of the light-colored resin increases the opacity of the background image 150 and reduces the ability of a viewer to perceive the color of the surface 108 through the background image 150. Thus, in some embodiments, the background image 150 is formed of one or more layers of the light-colored resin, two or more layers of the light-colored resin, or three or more layers of the light-colored resin. Each of the layers of the light-colored resin corresponds to a print operation performed using the thermal print head 104 and a background panel B of the print ribbon 106.

After the background image 150 has been printed to the surface 108, a conventional direct-to-substrate printing operation may commence, during which one or more of the colored dye panels 144 (Y-panel, C-panel, or M-panel), and/or the black resin panel K of the print ribbon 106 may be utilized to print the primary image 152 over the background image 150 using the thermal print head 104. This results in the primary image 152 overlaying the background image 150, as shown in FIGS. 6-8. As mentioned above, the background image 150 may be formed larger than the primary image, leaving a boarder 154 of the background image 150 surrounding the primary image 152.

When a reverse-image printing device is used to perform the print operation, such as device 100B (FIG. 2), the initial printing steps are generally reversed from that discussed above with regard to the direct-to-substrate printing operation to form the imaged transfer ribbon 124 shown in FIG. 9. For instance, the primary image 150 is initially printed to the surface 128 of the transfer layer 132 using one or more of the colored dye panels 144, and/or the black resin panel K of the print ribbon 106, in accordance with conventional printing techniques. In some embodiments, the primary image 152 sublimates into the transfer layer 132, as generally indicated in FIG. 9. Subsequently, the background image 150 is printed over the primary image 152, as shown in FIG. 9. The background image 150 may be printed in accordance with any of the embodiments described above to generally cover the primary image 152 with the light-colored resin. The resultant imaged transfer section of the transfer ribbon 124 may then be transferred to the surface 108 of a substrate 110 using the transfer unit 126 to form the image substrate 110 shown in FIGS. 6-8, for example.

During the transfer of the image transfer section shown in FIG. 9 to the surface 108 of a substrate 110, the transfer device 140 heats the thermal adhesive of the transfer layer 132 and the light-colored resin of the background image 150, and presses the imaged transfer section to the surface 108. The heated thermal adhesive and the heated light-colored resin of the background image 150 bond to the surface 108 and remain adhered to the surface 108 after the removal of the carrier layer 134. Thus, during this image transfer process, adhesive properties of the light-colored resin are utilized to bond the background image 150 to the surface 108 of the substrate 110. Accordingly, it is unnecessary to apply an additional adhesive over the background image 150 on the transfer layer 132 shown in FIG. 9 prior to performing the transfer operation using the transfer unit 126. Thus, embodiments of the present disclosure include the performance of the reverse-image transfer printing operation without a step of applying an adhesive to an exposed surface of the background image 150 printed to the transfer ribbon 124.

Although the present disclosure has been described with reference to preferred embodiments, workers skilled in the art will recognize that changes may be made in form and detail without departing from the spirit and scope of the present disclosure.

What is claimed is:

1. A method of printing an image using a thermal print unit, which includes a thermal print head and a print ribbon, the method comprising:
printing a background image to a surface of a substrate comprising transferring a light-colored resin from a background panel of the print ribbon to the substrate using the thermal print head; and
printing a primary image to the surface of the substrate including transferring print consumable from the print ribbon to the surface of the substrate using the thermal print head;
wherein the primary image overlays or underlays the background image on the substrate.

2. The method according to claim 1, wherein:
the print ribbon comprises:
a carrier layer;
a plurality of the background panels on the carrier layer, each background panel comprising the light-colored resin; and
a plurality of colored dye panels on the carrier layer, each colored dye panel including a print consumable on the carrier layer selected from the group consisting of a yellow dye, a magenta dye, and a cyan dye;
printing the background image comprises transferring the light-colored resin from the carrier layer to the substrate; and
printing the primary image comprises transferring the print consumable from at least one of the colored dye panels from the carrier layer to the substrate.

3. The method according to claim 1, wherein the primary image is within a perimeter of the background image.

4. The method according to claim 3, wherein:
the substrate comprises a transfer film;
printing the primary image is performed before printing the background image; and
the primary image underlays the background image on the substrate.

5. The method according to claim 4, further comprising transferring the background image and primary image from a carrier layer of the transfer film to a surface of a card substrate using a transfer unit.

6. The method according to claim 4, wherein the light-colored resin is white.

7. The method according to claim 3, wherein:
the substrate is a card substrate;
printing the primary image is performed after printing the background image; and
the primary image overlays the background image on the substrate.

8. The method according to claim 7, wherein the light-colored resin is white.

9. A print ribbon comprising:
a carrier layer;
a plurality of colored dye panels on the carrier layer; and
a plurality of light-colored resin background panels on the carrier layer.

10. The print ribbon according to claim 9, wherein the light-colored resin is white.

11. The print ribbon according to claim 10, wherein the colored dye panels are selected from the group consisting of a yellow dye panel, a magenta dye panel, and a cyan dye panel.

12. The print ribbon according to claim 11, further comprising one or more black resin panels on the carrier layer.

13. The print ribbon according to claim 9, wherein the print ribbon comprises a repeating series of print panels, each series including at least one background panel, and at least one of a colored dye panel and a black resin panel.

14. A credential production device comprising:
a transport mechanism configured to transport individual card substrates along a processing path; and
a thermal print unit comprising:
a print ribbon comprising:
a carrier layer;
a plurality of colored dye panels on the carrier layer; and
a plurality of light-colored resin background panels on the carrier layer; and
a print head configured to print images using the print ribbon.

15. The device according to claim 14, wherein the light-colored resin is white.

16. The device according to claim 15, wherein the colored dye panels are selected from the group consisting of a yellow dye panel, a magenta dye panel, and a cyan dye panel.

17. The device according to claim 16, further comprising one or more black resin panels on the carrier layer.

18. The device according to claim 14, wherein the print ribbon comprises a repeating series of print panels, each series including at least one background panel, and at least one of a colored dye panel and a black resin panel.

19. The device according to claim 18, wherein the print head is configured to print images to the substrates in the processing path using the print ribbon.

20. The device according to claim 18, further comprising:
a transfer ribbon; and
a transfer unit;
wherein:
the print head is configured to print images to the transfer ribbon using the print ribbon; and
the transfer unit is configured to transfer printed images from the transfer ribbon to the substrates in the processing path.
